(19) United States
(12) Patent Application Publication
(10) Pub. No.: US 2014/0077766 A1
(43) Pub. Date: Mar. 20, 2014

(54) CHARGING/DISCHARGING SUPPORT DEVICE

(71) Applicants: Eishi Takeuchi, Susono-shi (JP); Hiroyuki Ogawa, Susono-shi (JP); Yuki Yamada, Susono-shi (JP); Masato Endo, Nissin-shi (JP)

(72) Inventors: Eishi Takeuchi, Susono-shi (JP); Hiroyuki Ogawa, Susono-shi (JP); Yuki Yamada, Susono-shi (JP); Masato Endo, Nissin-shi (JP)

(73) Assignee: TOYOTA JIDOSHA KABUSHIKI KAISHA, Toyota-shi, Aichi (JP)

(21) Appl. No.: 14/003,150

(22) PCT Filed: May 25, 2011
(86) PCT No.: PCT/JP2011/061967

§ 371 Date: Sep. 4, 2013

(51) Int. Cl. B60L 11/18

(52) U.S. Cl. CPC B60L 11/1824
USPC 320/128

(57) ABSTRACT

A charging/discharging support center provides normal power sales/purchase price information, including a power purchase price of power purchased to charge a battery of a vehicle and a power sales price of power discharged from the battery for sale, depending on whether it is busy hours during which a large-scale store is crowded or slow hours during which the large-scale store is not crowded, based on the past record. When the traffic volume in the surrounding area of the large-scale store is predicted to increase, the charging/discharging support center changes the power sales/purchase price information and provides, to a user of the vehicle, power sales/purchase price information in which the power purchase price of power purchased to charge the battery at the store is increased and set high, whereas the power sales price of power discharged from the battery for sale is reduced and set cheap.

### TECHNICAL FIELD

The present invention relates to a charging/discharging support device that assists in charging a battery that is mounted on a vehicle with electric power purchased and in discharging the battery in order to sell electric power.

### BACKGROUND ART

Hitherto, there have been known methods and devices for controlling a power source, for example, one described in Patent Literature 1. This conventional power source control method and device collects at least one type of information obtained from a rechargeable vehicle that has a battery or from a user thereof, gives points to each type of information collected, and charges the battery by an amount that is determined by the points given. In giving points, the conventional power source control method and device weights each type of information collected (positional information of the rechargeable vehicle) depending on the degree of usefulness to a store that the user uses. This ensures that the user side and the store side both are benefitted.

Further, hitherto, there have been known systems, methods, and programs for managing power supply at a power charging station, for example, one described in Patent Literature 2. In this conventional system, method, and program for managing power supply at a power charging station, the positional information of a power charging station for charging electric vehicles is obtained, the weather forecast at the location of the power charging station is obtained, the traffic forecast at the location of the power charging station is obtained, the amount of power necessary for the power charging station is calculated with the use of the obtained weather forecast and traffic forecast, and the amount of power to be purchased from a power market is determined based on the calculated amount of power. The total amount of power necessary for all power charging stations are thus bought en masse from a power market inexpensively to be fed to the respective power charging stations.

### CITATION LIST

### Patent Literature

[PTL 1] JP 2009-183135 A
[PTL 2] JP 2007-206889 A

### SUMMARY OF INVENTION

In the conventional power source control method and device described in Patent Literature 1, points are given by weighting the positional information of a rechargeable vehicle, and can be used to charge the battery. In other words, this conventional power source control method and device gives points when, for example, a user visits a store. It is therefore expected that users who wish to earn points visit stores regardless of the busy hours or slow hours of the stores.

The conventional power source control method and device does not present any kind of information to users of rechargeable vehicles, nor provides assistance. The users are therefore utterly free in visiting stores to park and charge the rechargeable vehicles. This means that in some cases, the parking lot of a store is constantly in use during the hours when many users are active (visit the store), and the store is crowded as a result. The congestion of the store can also cause a traffic jam on a road leading to the store, which is a great inconvenience to residents of the surrounding area of the store.

The present invention has been made in view of the problem described above, and an object of the present invention is to provide a charging/discharging support device that assists in charging/discharging a battery that is mounted on a vehicle by providing information for preventing the congestion of vehicles.

In order to achieve the above-mentioned object, according to a feature of the present invention, there is provided a charging/discharging support device for assisting in charging or discharging a battery of a plug-in electric vehicle in a charging/discharging parking space by charging/discharging means for at least charging the battery of the plug-in electric vehicle out of charging and discharging, the charging/discharging means being provided in the charging/discharging parking space the charging/discharging parking space being provided at a facility including a parking lot for parking a plurality of vehicles, the charging/discharging support device including: congestion information obtaining means for obtaining congestion information that indicates a congestion situation inside the facility or around the facility; charging/discharging-related information changing means for changing information about the charging or discharging of the battery by the charging/discharging means, depending on the congestion situation that is indicated by the congestion information obtained by the congestion information obtaining means; and presenting means for presenting to a user of the plug-in electric vehicle the information about the charging or discharging of the battery by the charging/discharging means that has been changed by the charging/discharging-related information changing means. In this case, it is preferred for the congestion information obtaining means to include traffic volume obtaining means for obtaining a traffic volume around the facility, and to obtain congestion information that indicates the congestion situation with use of the traffic volume around the facility obtained by the traffic volume obtaining means. It is also preferred for the congestion information obtaining means to further include traffic volume temporal differentiation means for performing temporal differentiation on the traffic volume obtained by the traffic volume obtaining means, and to obtain congestion information that indicates a future congestion situation inside the facility or around the facility, which is predicted with use of the traffic volume obtained by the traffic volume obtaining means and a temporal differentiation value of the traffic volume calculated through temporal differentiation by the traffic volume temporal differentiation means.

In this case, it is preferred that the information about the charging or discharging of the battery by the charging/discharging means be a condition for charging the battery by the charging/discharging means, and be information about a power purchase price of power purchased to charge the battery, and that the charging/discharging-related information changing means change the information about the charging or discharging of the battery by the charging/discharging means so that the power purchase price of power purchased to charge the battery is higher when the congestion information obtained by the congestion information obtaining means indicates that the inside of the facility or surroundings of the facility are crowded, than when the inside of the facility or surroundings of the facility are not crowded.

Further, in those cases, it is preferred that the information about the charging or discharging of the battery by the charging/discharging means be a condition for discharging the battery by the charging/discharging means, and be information about a power sales price of power discharged from the battery for sale, and that the charging/discharging-related information changing means change the information about the charging or discharging of the battery by the charging/discharging means so that the power sales price of power discharged from the battery for sale is lower when the congestion information obtained by the congestion information obtaining means indicates that the inside of the facility or surroundings of the facility are crowded, than when the inside of the facility or surroundings of the facility are not crowded.

According to those, the information about the charging/discharging of the battery to be provided to a user of the plug-in electric vehicle can be changed depending on the congestion situation inside the facility or around the facility (e.g., the absolute quantity of the traffic volume or a change with time of the traffic volume). Specifically, the power purchase price of power purchased to charge the battery can be increased and set high when there is congestion inside the facility or around the facility, whereas the power purchase price of power purchased to charge the battery can be reduced and set low when there is no congestion inside the facility or around the facility. The power sales price of power discharged from the battery for sale can be reduced and set cheap when there is congestion inside the facility or around the facility, whereas the power sales price of power discharged from the battery for sale can be increased and set high when there is no congestion inside the facility or around the facility.

By providing the thus changed information about the charging/discharging of the battery, the action of users can be controlled effectively. The congestion (traffic volume) in the surrounding area of the facility can thus be leveled and the congestion of plug-in electric vehicles at the facility can be effectively prevented.

Further, it is preferred that the presenting means present, at least, the information about the charging or discharging of the battery by the charging/discharging means that has been changed by the charging/discharging-related information changing means when the plug-in electric vehicle approaches to within a given distance of the facility that is set in advance. According to this, the user can grasp the congestion situation inside/outside the facility based on the information about the charging/discharging of the battery that is provided before the user arrives at the facility. The user can therefore act accordingly by, for example, delaying the time when the user heads into the facility. In other words, the action of users can effectively be controlled by this, too. The congestion (traffic volume) in the surrounding area of the facility can be leveled as a result and the congestion of plug-in electric vehicles at the facility can be effectively prevented.

In addition, the presenting means may present, at least, the information about the charging or discharging of the battery by the charging/discharging means that has been changed by the charging/discharging-related information changing means when a destination is set in a navigation unit that is usable by a user of the plug-in electric vehicle. According to this, the user can grasp the congestion situation inside/outside the facility based on the information about the charging/discharging of the battery that is provided when the user sets the destination in the navigation unit to make a drive plan. The user can thus make an appropriate drive plan. In other words, the action of users can effectively be controlled by this, too. The congestion (traffic volume) in the surrounding area of the facility can be leveled as a result and the congestion of plug-in electric vehicles at the facility can be effectively prevented.

### BRIEF DESCRIPTION OF DRAWINGS

FIG. 1 is a schematic diagram of a charging/discharging support system that includes a charging/discharging support device according to an embodiment of the present invention.

FIG. 2 is a schematic diagram illustrating the configuration of a vehicle that constitutes a part of the charging/discharging support system of FIG. 1, and the configuration of a charging/discharging station that is connected electrically to the vehicle.

FIG. 3 is a schematic diagram illustrating the configuration of an information terminal device of FIG. 1.

FIG. 4 is a schematic diagram illustrating the configuration of a charging/discharging support center of FIG. 1.

FIG. 5 is a schematic diagram illustrating the configuration of a large-scale facility of FIG. 1.

FIG. 6 is a schematic diagram illustrating the configuration of a traffic information providing center of FIG. 1.

FIG. 7 is a flow chart of a charging/discharging support program that is executed in the charging/discharging support center of FIG. 1 and FIG. 4.

FIG. 8 is a schematic graph showing normal power sales/purchase price information that includes power purchase price and power sales price set depending on whether it is normal busy hours or normal slow hours at the large-scale facility.

FIG. 9 is a schematic graph showing hour-to-hour changes in traffic volume in the surrounding area of the large-scale facility.

FIG. 10 is a schematic graph showing leveling power sales/purchase price information that includes power purchase price and power sales price set depending on whether it is busy hours or slow hours in order to level the visitor count of the large-scale facility and the traffic volume.

### DESCRIPTION OF EMBODIMENT

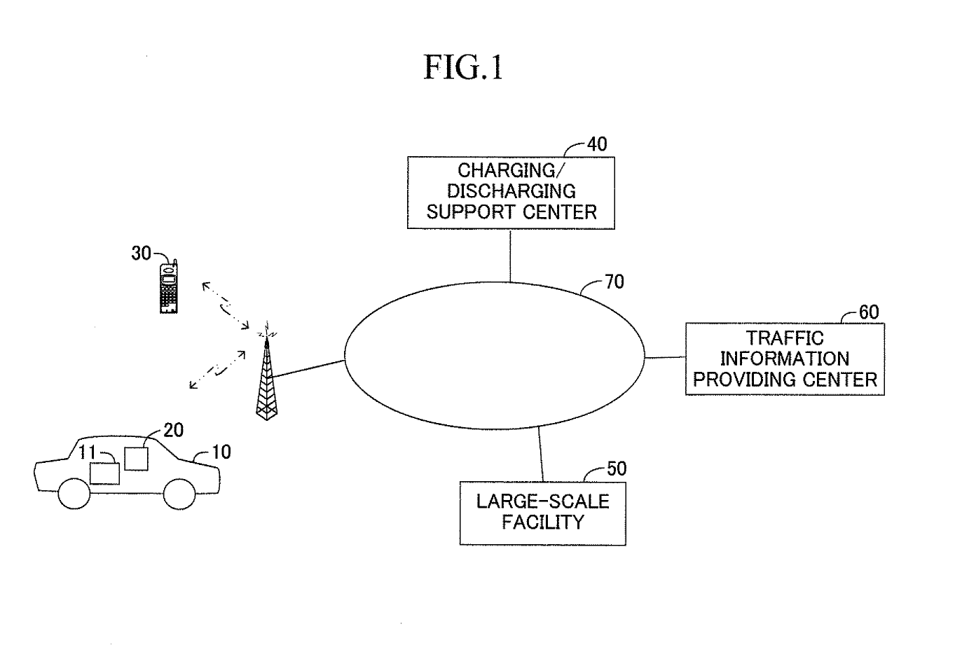

Now, an embodiment of the present invention is described in detail with reference to the drawings. FIG. 1 is a schematic block diagram illustrating schematically a charging/discharging support system that includes a charging/discharging support device according to the embodiment of the present invention.

This charging/discharging support system includes an information terminal device 20, which is mounted on a vehicle 10, a portable information terminal device 30, which is carried by a user of the vehicle 10, a charging/discharging support center 40, which provides charging/discharging-related information about charging/discharging to the information terminal device 20 and the portable information terminal device 30, a large-scale facility 50, which the user of the vehicle 10 can use, and a traffic information providing center 60, which checks and provides the traffic volume in the surrounding area of the large-scale facility 50. The information terminal device 20, the portable information terminal device 30, the charging/discharging support center 40, the large-scale facility 50, and the traffic information providing center 60 are each connected to a network 70 (e.g., the Internet network, a leased line network, or the smart grid network built by a power company that controls the supply of commercial electric power).

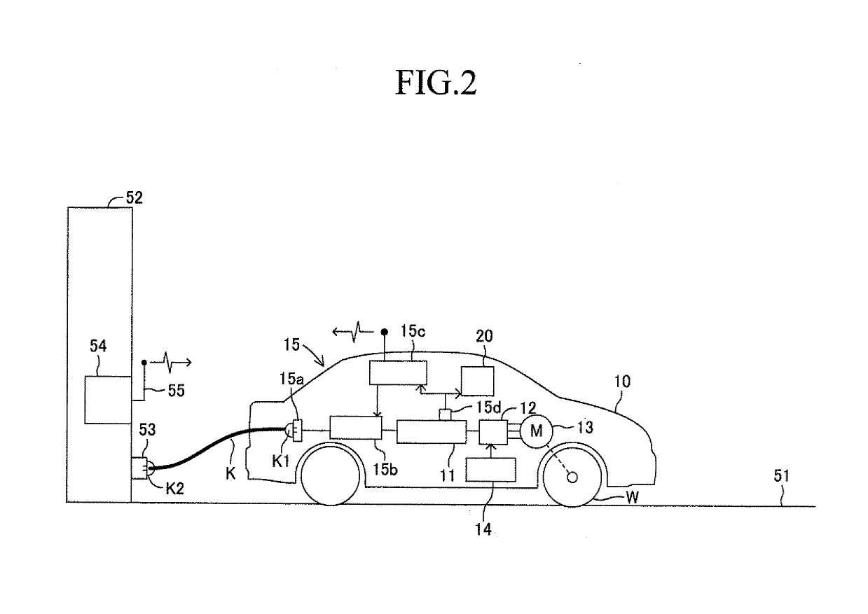

The vehicle 10 that constitutes a part of the charging/discharging support system is, as schematically illustrated in FIG. 2, a plug-in electric vehicle on which a large-capacity battery 11 is mounted to be charged by and discharged to an external commercial power source, for example, an electric vehicle (EV) that runs on power from the battery 11, a plug-in hybrid vehicle (PHV) that additionally has an internal combustion engine, or a two-wheeled vehicle such as an electric bicycle, a power-assisted bicycle, or an electric motorcycle. The configuration of the vehicle 10 itself can be a known configuration and is not directly relevant to the present invention. A brief description is therefore given below on the configuration of the vehicle 10.

As illustrated in FIG. 2, the vehicle 10 includes, as a driving system, an inverter 12, which converts direct current output from the battery 11 into three-phase alternating power, a driving motor 13, which is driven on the three-phase alternating power output from the inverter 12 to rotate wheels W, and a motor control unit 14 (hereinafter referred to as “motor ECU 14”), which controls the output of the inverter 12. The motor ECU 14 controls power supplied to the driving motor 13 from the battery 11 via the inverter 12, thereby enabling the vehicle 10 to run.

The vehicle 10 also includes a charging/discharging system 15 for charging the battery 11 with purchased power and discharging the battery 11 to sell power. The charging/discharging system 15 includes, as illustrated in FIG. 2, a power receiving/feeding connector 15a, which is provided in a manner that allows the power receiving/feeding connector 15a to connect to a plug K1 of a charging/discharging connection cable K, a known charge/discharge circuit 15b, which controls switching between the charging of the battery 11 and the discharging of the battery 11, a vehicle-side charging/discharging control unit 15c (hereinafter referred to as “vehicle-side charging/discharging ECU 15c”), which controls the charging/discharging of the battery 11 via the charge/discharge circuit 15b. In the charging/discharging system 15, an SOC detecting portion 15d is also provided in the battery 11 to detect the state of charge (SOC), which is a value indicating the charging state (the amount of power) of the battery 11. The SOC detecting portion 15 outputs a signal indicating the SOC to the vehicle-side charging ECU 15c. If necessary, the vehicle 10 may be configured so that the signal from the SOC detecting portion 15d that indicates the SOC is output to the information terminal device 20, too, as illustrated in FIG. 2.

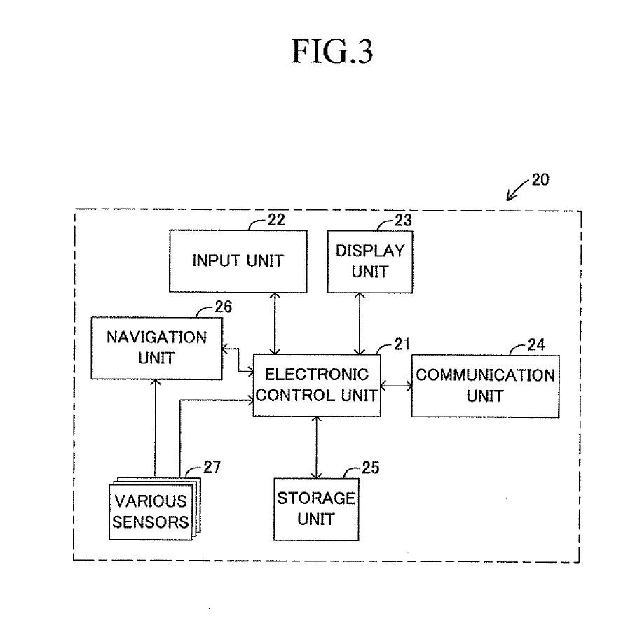

The information terminal device 20 is installed in the vicinity of the driver seat of the vehicle 10, for example, and obtains from the charging/discharging support center 40 various types of information useful in charging/discharging the battery 11 of the vehicle 10 at the large-scale facility 50 to present the information to a user who heads to the facility 50 by means of the vehicle 10. To that end, the information terminal device 20 includes, as illustrated schematically in FIG. 3, an electronic control unit 21, an input unit 22, a display unit 23, a communication unit 24, a storage unit 25, a navigation unit 26, and various sensors 27, which are connected in a manner that allows communication to/from one another.

The electronic control unit 21 is a microcomputer of which main components are a CPU, a ROM, a RAM, and others, and exerts overall control on the operation of the information terminal device 20 by executing various programs. The electronic control unit 21 is provided with, for example, a known interface that connects to the various sensors 27 and others in a manner that allows communication in order to obtain various detected values detected by the various sensors 27. The electronic control unit 21 uses the interface to obtain from the SOC detecting portion 15d the signal indicating the SOC as the need arises. The input unit 22 includes an operation switch provided in the vicinity of the display unit 23, a panel touch switch that is incorporated in the display unit 23 to detect touch operation on a display panel, and others, and allows the user to enter various inputs. The display unit 23 includes, for example, a liquid crystal display, and displays text, graphics, and the like on the display panel.

As illustrated in FIG. 1, the communication unit 24 enables the information terminal device 20 to hold, via a relay station, wireless communication to/from the charging/discharging support center 40, which is connected to the network 70. The storage unit 25 includes a storage medium such as a hard disk or a semiconductor memory and a drive for the storage medium. The storage unit 25 stores in advance a program and data that are needed by the electronic control unit 21 in exerting overall control on the operation of the information terminal device 20, and also stores in advance various types of data (e.g., map data or road data) necessary for route search that is conducted by the navigation unit 26.

The navigation unit 26 uses the various types of data stored in advance in the storage unit 25, or uses various types of data obtained via the communication unit 24 from, for example, an information providing center (not shown) that is connected to the network 70, in the search for a route to a destination specified by the user. The navigation unit 26 presents the found route as navigation. The various sensors 27 obtain data (detected values) necessary for the route search and navigation by the navigation unit 26. The various sensors 27 include, for example, a Global Positioning System (GPS) signal detecting sensor as a sensor necessary to detect the current location of the information terminal device 20 (i.e., the vehicle 10), and a speed sensor for detecting the speed of the vehicle 10 (i.e., the traveling speed of this device 30), among others.

The portable information terminal device 30 has, though not shown in the drawing, a configuration substantially the same as that of the information terminal device 20 described above, and includes an electronic control unit, an input unit, a display unit, a storage unit, a communication unit, a navigation unit, and various sensors that are connected in a manner that allows communication to/from one another. The portable information terminal device 30, however, has a compact configuration so that the user can carry the portable information terminal device 30 around. The portable information terminal device 30 can be, for example, a cellular phone, a smartphone, a tablet terminal, or a notebook computer.

This embodiment is carried out by employing, as a rule, the information terminal device 20 that is used mounted on the vehicle 10 and the portable information terminal device 30 that is used carried by the user as devices for obtaining the charging/discharging-related information about charging/discharging from the charging/discharging support center 40 and presenting the information to the user. It is to be understood, however, that because the information terminal device 20 and the portable information terminal device 30 have substantially the same configuration as described above and can function in a similar manner, this embodiment may be carried out by, for example, omitting the information terminal device 20 so that the user uses the portable information terminal device 30 alone. The portable information terminal device 30 can operate in this case, too, as described later, and is capable of obtaining useful information about charging/discharging and presenting the information to the user.

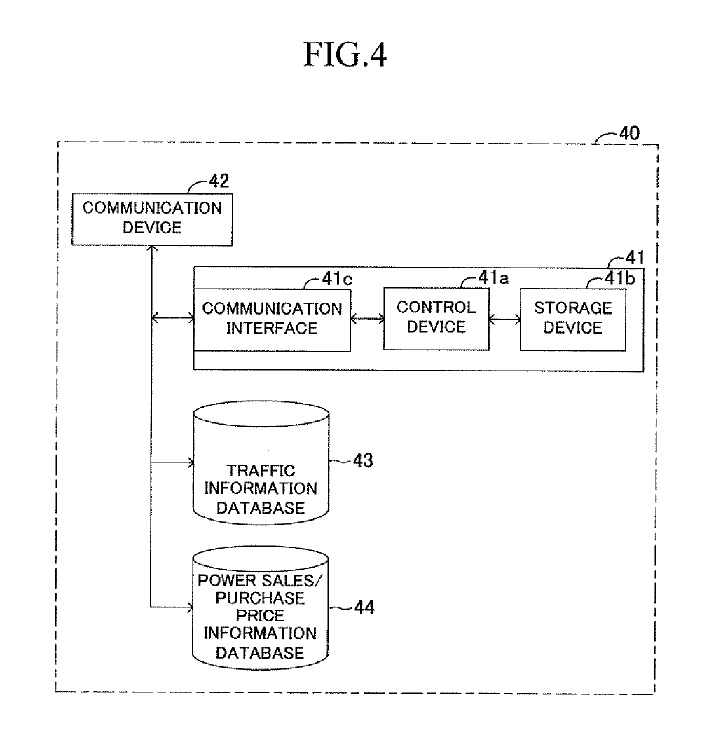

The charging/discharging support center 40 includes, as illustrated in FIG. 4, an information managing/providing server 41 and a communication device 42 that are connected in a manner that allows communication to/from each other. The information managing/providing server 41 includes a control device 41a, a storage device 41b, and a communication interface 41c. The control device 41a, too, has as a main component a microcomputer, which includes a CPU, a ROM, a RAM, and others. The control device 41a exerts overall control on the operation of the information managing/providing server 41 by executing various programs that include one described later. The storage device 41b includes a storage medium such as a hard disk and a drive for the storage medium to store various programs including one described later and various types of data. The communication interface 41c is an interface for connecting to a communication line (e.g., a LAN line) that is built inside the charging/discharging support center 40. The communication device 42 is connected to the network 70 by a cable to hold wired communication to/from the large-scale facility 50 and the traffic information providing center 60, and also allows the charging/discharging support center 40 to hold wireless communication to/from the information terminal device 20 and the portable information terminal device 30 via a relay station.

In the charging/discharging support center 40, a traffic information database 43 and a power sales/purchase price information database 44 are also built as illustrated in FIG. 4. These databases 43 and 44 are connected to the communication line built inside the charging/discharging support center 40 to be accessible to the information managing/providing server 41.

The traffic information database 43 stores the traffic volume of a road in the surrounding area of the large-scale facility 50 out of various types of information provided by the traffic information providing center 60. The stored information is updated as the need arises. The power sales/purchase price information database 44 stores, in an updatable manner, power sales/purchase price information that is set for each different period of hours of the day as a charging/discharging condition as described later, and the past record of fluctuation of the power sales/purchase price information. The power sales/purchase price information includes power purchase price information, which indicates the purchase price of power purchased to charge the battery 11, and power price sales information, which indicates the power sales price of power discharged from the battery 11 for sale.

The large-scale facility 50 is, for example, a large shopping mall which the user visits by means of the vehicle 10. On the premises of the large-scale facility 50, a plurality of charging/discharging spaces 51 are created to charge the battery 11 of the vehicle 10 (to purchase power) or to discharge the battery 11 of the vehicle 10 (to sell power) as illustrated in FIG. 2. A charging/discharging station 52 as charging/discharging means is installed in each charging/discharging space 51.

The charging/discharging station 52 includes a charging/discharging socket 53. A plug K2 of the charging/discharging connection cable K is plugged into the charging/discharging socket 53 and the plug K1 of the charging/discharging cable K is simultaneously plugged into the power receiving/feeding connector 15a of the charging/discharging system 15 as described above. In this state, the vehicle-side charging/discharging ECU 15c controls the switching of the charge/discharge circuit 15b so that power is supplied from the charging/discharging station 52 to the battery 11 in the case where the battery 11 of the vehicle 10 is charged (in the case of purchasing power), whereas power is supplied from the battery 11 to the charging/discharging station 52 in the case where the battery 11 of the vehicle 10 is discharged (in the case of selling power). The voltage supplied from the charging/discharging socket 53 to charge the battery 11 is set to 100 V or 200 V to match the set supply voltage value of the vehicle 10 to be charged.

The charging/discharging station 52 also includes a charging/discharging control unit 54 (hereinafter referred to as “charging/discharging ECU 54”) and a communication unit 55. The charging/discharging ECU 54 has a microcomputer as a main component, and uses the communication unit 55 to hold, via a communication antenna, short-distance wireless communication to/from the vehicle-side charging/discharging ECU 15c of the charging/discharging system 15 as illustrated in FIG. 2, thereby ensuring that the battery 11 is charged/discharged by an appropriate amount of power. In other words, the charging/discharging ECU 54 and the vehicle-side charging/discharging ECU 15c charge/discharge the battery 11 appropriately by transmitting/receiving various types of information (e.g., a request code or a response code in charging/discharging, ID information for identifying the type of the vehicle 10, or the SOC of the battery 11) to/from each other in given cycles.

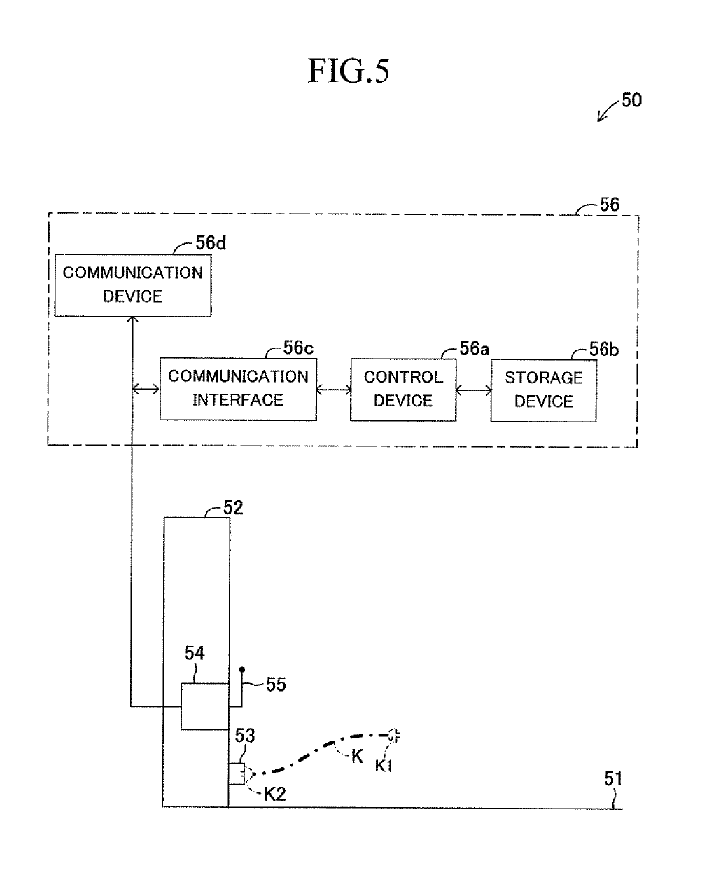

The large-scale facility 50 further includes, as illustrated in FIG. 5, a management server 56 that is connected in a manner that allows communication to/from others. The management server 56 includes a control device 56a, a storage device 56b, a communication interface 56c, and a communication device 56d. The control device 56a, too, has as a main component a microcomputer that includes a CPU, a ROM, a RAM, and others. The control device 56a exerts overall control on the operation of the management server 56 (specifically, processing of presenting to the charging/discharging support center 40 the power sales/purchase price information or the like and other types of processing described later). The storage device 56b includes a recording medium such as a hard disk and a drive for the storage medium to store various programs and various types of data that are used by the control device 56a. The communication interface 56c is an interface for connecting to a communication line (e.g., a LAN line) and holds, via the communication line, communication to/from the charging/discharging station 52 (more exactly, the charging/discharging ECU 54) that is provided in each charging/discharging parking space 51. The communication device 56 is connected to the network 70 by a cable to hold wired communication to/from the charging/discharging support center 40.

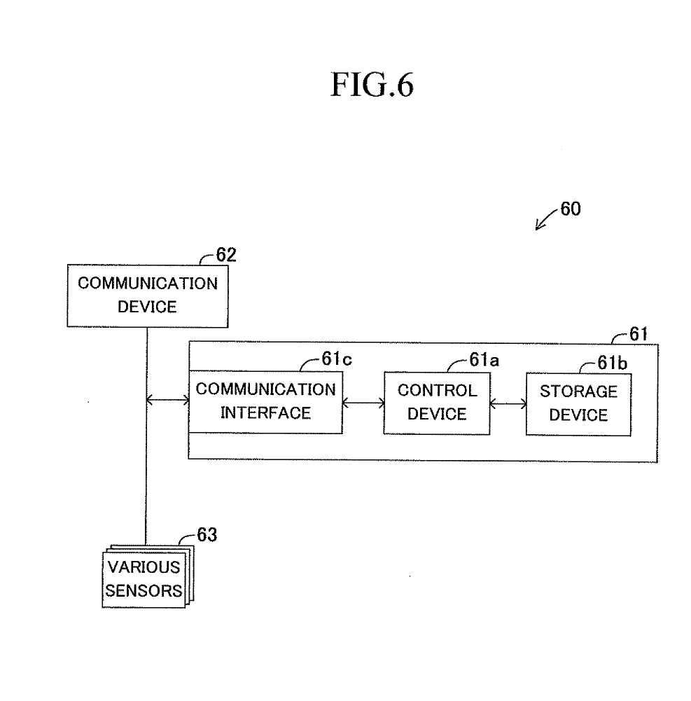

The traffic information providing center 60 includes, as illustrated in FIG. 6, a management server 61 and a communication device 62 that are connected in a manner that allows communication to/from each other. The management server 61 includes a control device 61a, a storage device 61b, and a communication interface 61c. The control device 61a, too, has as a main component a microcomputer that includes a CPU, a ROM, a RAM, and others. The control device 61a exerts overall control on the operation of the management server 61 (specifically, measurement of the traffic volume in the surrounding area of the large-scale facility 50, and the like). The storage device 61b includes a recording medium such as a hard disk and a drive for the storage medium to store various programs and various types of data that are used by the control device 61a. The communication interface 61c is an interface for connecting to a communication line (e.g., a leased line) and holds communication to/from various sensors 63. The communication device 62 is connected to the network 70 by a cable to hold wired communication to/from the charging/discharging support center 40.

The various sensors 63 are a group of sensors installed by the side of a road, underground, or above a road to detect the count of vehicles driving on the road, the speed of a vehicle, and the like by a known method that uses, for example, communication between a vehicle and the road (road-vehicle communication), sound, or light. The various sensors 63 output detected values such as the detected count of vehicles driving on the road and the detected vehicle speed to a communication line. The detected values output to the communication line are supplied to the control device 61a via the communication interface 61c.

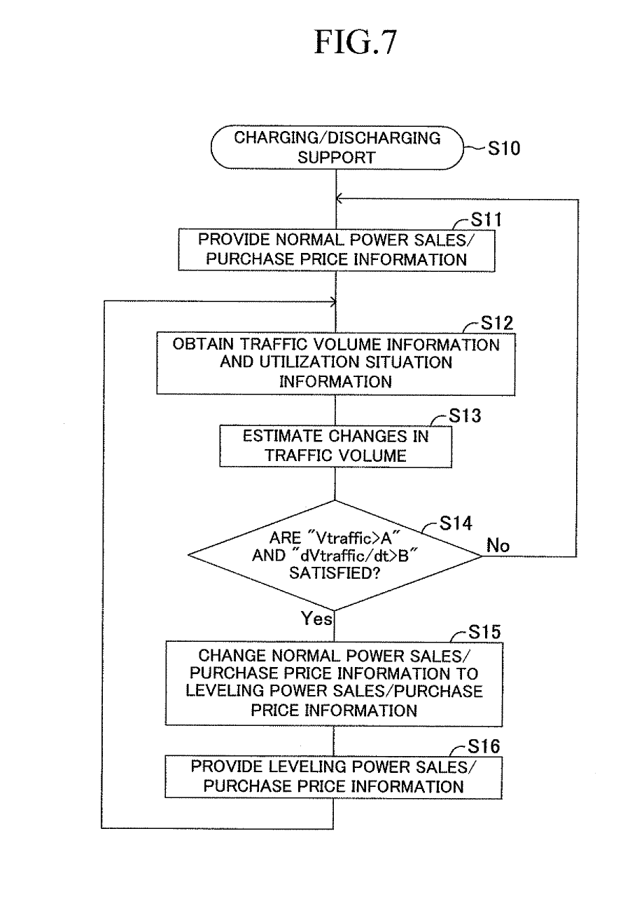

A concrete description is given next on the operation of the thus configured embodiment with reference to FIG. 7. In the large-scale facility 50 such as a large shopping mall in a suburb, a user (customer) who visits the large-scale facility 50 by means of the vehicle 10 can park the vehicle 10 in one of the charging/discharging parking spaces 51. The user can use the charging/discharging station 52 installed in the charging/discharging parking space 51 in the manner described above to charge the battery 11 of the vehicle 10 with purchased power or discharge the battery 11 to sell power accumulated in the battery 11.

The charging/discharging of the battery 11 described above takes a relatively long period of time in general. Users (customers) therefore tend to charge/discharge the battery 11 when the users have reason to visit the large-scale facility 50, for example, when the users have shopping to do in the case where the large-scale facility 50 is a shopping mall. Consequently, the charging/discharging parking spaces 51 are kept occupied for a long period of time in some cases. In such cases, other users (customers) who wish to use the charging/discharging parking spaces 51 cannot park their vehicles 10 quickly, which could result in a traffic jam along a road in the surrounding area of the shopping mall.

The power purchase price at which power is purchased and the power sales price at which power is sold fluctuate depending on the supply and demand of power. For instance, the power sales price and the power sales price tend to rise as the demand for power increases. For example, users (customers) who plan to visit the shopping mall and discharge the battery 11 during shopping in order to sell power accumulated in the battery 11 are therefore inclined to visit the shopping mall during hours when the power sales price is higher. Based on this way of thinking, a consequence of many users (customers) acting similarly may be, for example, heavier traffic due to the congestion of vehicles including the vehicles 10 on a road leading to the shopping mall. Under the circumstance where the visit to the shopping mall is concentrated, users (customers) who wish to use the charging/discharging parking spaces 51 cannot park their vehicles quickly, which could result in a traffic jam along a road in the surrounding area of the shopping mall.

The situation where the traffic in the surrounding area of the large-scale facility 50 (e.g., a shopping mall) increases to cause a traffic jam is a great inconvenience to residents of the area. The charging/discharging support center 40 therefore provides users of the vehicle 10 with power sales/purchase price information as a charging/discharging condition that is useful in selling or purchasing power for the battery 11 at the large-scale facility 50 (e.g., a shopping mall), thus preventing the vehicles 10 from congesting at the large-scale facility 50 and the resultant increase in traffic in the surrounding area, more exactly, thus leveling the traffic volume in the surrounding area of the large-scale facility 50 and the count of visitors of the large-scale facility 50. For that purpose, the information managing/providing server 41 of the charging/discharging support center 40 executes a charging/discharging support program that is illustrated in the flow chart of FIG. 7. The charging/discharging support program is described in detail below.

In the information managing/providing server 41 of the charging/discharging support center 40, the control device 41a (more exactly, the CPU) starts executing the charging/discharging support program of FIG. 7 in Step S10. In the following Step S11, the control device 41a obtains power sales/purchase price information at a normal time (hereinafter referred to as “normal power sales/purchase price information”) that is set by the large-scale facility 50 (shopping mall). The control device 41a transmits the obtained normal power sales/purchase price information to the information terminal device 20 and the portable information terminal device 30 to present the information. A concrete description on Step S11 is given below.

In a shopping mall that is the large-scale facility 50, the visiting customer count is usually predicted for each different period of hours of the day based on the past trend, and the amount of stock merchandise or the like that is laid in is adjusted based on the prediction. Specifically, hours of the day of the shopping mall that is the large-scale facility 50 include busy hours during which the visiting customer count is high and slow hours during which the visiting customer count is low, and the busy hours and the slow hours are predicted so that actions are taken accordingly. As described above, users (customers) of the vehicles 10 tend to charge/discharge the battery 11, in other words, sell/purchase power when the users have shopping to do or otherwise have a reason to visit the shopping mall. If users of the vehicles 10 visit the shopping mall as customers in the busy hours, the charging/discharging parking spaces 51 are therefore kept occupied for a long period of time whereas the charging/discharging parking spaces 51 remain free in the slow hours of the shopping mall.

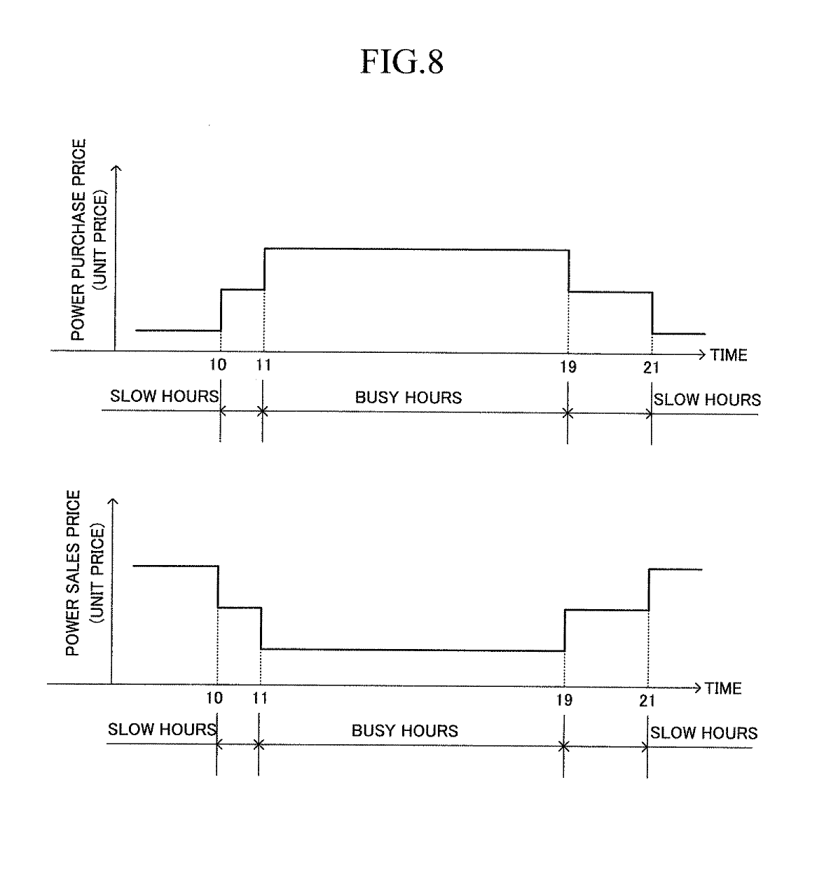

In order to use the charging/discharging parking spaces 51 efficiently, in other words, to use the charging/discharging parking spaces 51 efficiently by taking into account the busy hours and the slow hours, it is thus effective to increase the visitor count of users (customers) of the vehicles 10 who visit the shopping mall during the slow hours while reducing the visitor count of users (customers) of the vehicles 10 who visit the shopping mall during the busy hours. The shopping mall that is the large-scale facility 50 therefore sets in advance the normal power sales/purchase price for each different period of hours of the day (i.e., for each of the busy hours and slow hours predicted in the manner described above) as shown in FIG. 8 in order to effectively prevent users of the vehicles 10 from visiting the shopping mall during the busy hours and to effectively prompt the users to visit the shopping mall during the slow hours.

To give a concrete description, the shopping mall that is the large-scale facility 50 is a store open from 10 a.m. to 9 p.m. In this shopping mall, one hour from 10 a.m., at which the store opens for the day, to 11 a.m. and two hours from 7 p.m. to 9 p.m., at which the store closes for the day, correspond to the slow hours, and the power purchase price (unit price) of power with which the battery 11 is charged is therefore set cheap during these hours. The power sales price (unit price) of power discharged from the battery 11 is set high during the hours of the day that correspond to the slow hours. On the other hand, the busy hours in this shopping mall start at 11 p.m., which is one hour past the opening of the store for the day, and end at 7 p.m., and the power purchase price (unit price) of power with which the battery 11 is charged is therefore set higher during these hours than during the slow hours. The power sales price (unit price) of power discharged from the battery 11 is set lower during the hours of the day that correspond to the busy hours than during the slow hours.

The thus set normal power sales/purchase price information is stored at a given storage location in the storage device 56b of the management server 56, which is provided in the large-scale facility 50. The control device 56a of the management server 56 thus obtains the normal power sales/purchase price information stored in the storage device 56b in accordance with, for example, request information transmitted via the network 70 from the information managing/providing server 41 of the charging/discharging support center 40, and transmits the normal power sales/purchase price information to the information managing/providing server 41 of the charging/discharging support center 40 via the communication device 56d and the network 70.

The information managing/providing server 41 of the charging/discharging support center 40 receives, via the communication device 42, the normal power sales/purchase price information transmitted from the management server 56 of the large-scale facility 50, and the control device 41a stores the received information at a given storage location in the power sales/purchase price information database 44 via the communication interface 41c. The control device 41a transmits the normal power sales/purchase price information stored in the power sales/purchase price information database 44 to the information terminal device 20 and the portable information terminal device 30 to present the information to the user of the vehicle 10. The normal power sales/purchase price information may be transmitted (provided) automatically from the information managing/providing server 41 (more exactly, the control device 41a) of the charging/discharging support center 40 to the information terminal device 20 and the portable information terminal device 30, or may be transmitted when the user requests the information managing/providing server 41 (more exactly, the control device 41a) of the charging/discharging support center 40 to provide the information by using at least one of the information terminal device 20 and the portable information terminal device 30.

When the normal power sales/purchase price information is provided from the information managing/providing server 41 of the charging/discharging support center 40 in this manner, the user of the vehicle 10 can use the information terminal device 20 or the portable information terminal device 30 to, for example, check the power sales/purchase price set for each different period of hours of the day as shown in FIG. 8. The user can thus make a plan for visiting the shopping mall that is the large-scale facility 50 by referring to the provided normal power sales/purchase price information. To give a concrete example, in the case where the user of the vehicle 10 has planned to go to the shopping mall after noon to shop and charge the battery 11 (or discharge the battery 11) and is then provided with the normal power sales/purchase price information, the user can change the plan to leave earlier in order to visit the shopping mall immediately after the store opens for the day and avoid the higher power purchase price (unit price) (or cheaper power sales price (unit price)) set for afternoon hours.

With this, users of the vehicles 10 can sell/purchase power for the battery 11 during hours when the power purchase price (unit price) is cheap (or the power sales price (unit price) is high), while the shopping mall that is the large-scale facility 50 can reduce the count of users (customers) of the vehicles 10 who visit during the busy hours and increase the count of users (customers) of the vehicles 10 who visit during the slow hours. The congestion of the vehicles 10 at the shopping mall that is the large-scale facility 50 is thus prevented effectively. In other words, the traffic volume along a road in the surrounding area is prevented from increasing by leveling the count of the vehicles 10 that visit the shopping mall. After transmitting and providing the normal power sales/purchase price information to the information terminal device 20 and the portable information terminal device 30 as described above, the control device 41a of the information managing/providing server 41 proceeds to Step S12.

In Step S12, the control device 41a of the information managing/providing server 41 obtains, from the traffic information providing center 60, traffic volume information that indicates the traffic volume as the congestion situation in the surrounding area of the large-scale facility 50. The control device 41a of the information managing/providing server 41 further obtains utilization situation information that indicates the utilization situation (namely, the congestion situation) of the charging/discharging parking spaces 51 from the large-scale facility 50.

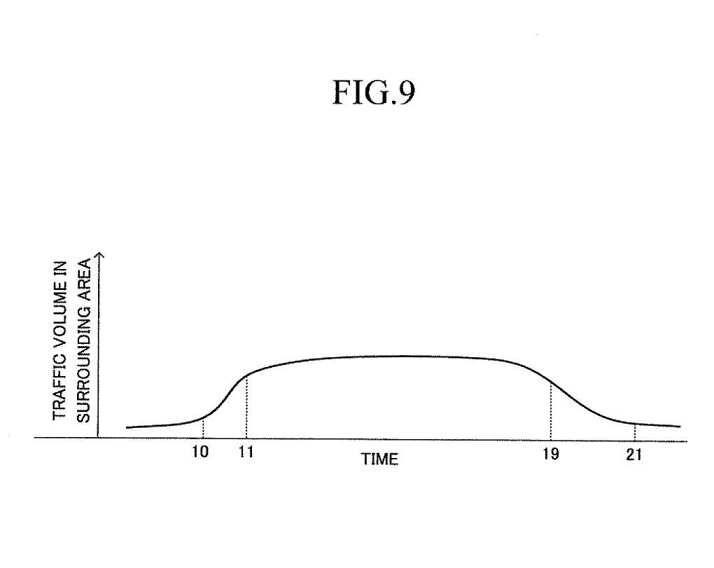

To give a concrete description, in the traffic information providing center 60, the control device 61a of the management server 61 obtains detected values such as the count and speed of vehicles driving on a road in the surrounding area of the shopping mall that is the large-scale facility 50 with the use of the communication interface 61c, and stores the obtained detected values at a given storage location in the storage device 61b in association with a time at which the detected values have been obtained. The control device 61a of the management server 60 then selects a detected value about a road leading to the shopping mall that is the large-scale facility 50 (a road approaching the shopping mall) from among the detected values stored in the storage device 61b, and transmits the selected detected value as the traffic volume information shown in FIG. 9 to the charging/discharging support center 40, which is connected to the network 70, with the use of the communication device 62. The information managing/providing server 41 of the charging/discharging support center 40 receives, via the communication device 42, the traffic volume information transmitted from the management server 61 of the traffic information providing center 60, and the control device 41a stores the received information at a given storage location in the traffic information database 43 via the communication interface 41c.

In the large-scale facility 50, the control device 56a of the management server 56 holds communication to/from the charging/discharging ECU 54 of the charging/discharging station 52, which is installed in each charging/discharging parking space 51. The control device 56a of the management server 56 thus obtains the count of the charging/discharging parking spaces 51 where the vehicles 10 are currently parked based on whether or not the charging/discharging ECU 54 is obtaining various types of information from the vehicle-side charging/discharging ECU 15c through short-distance wireless communication, and stores the obtained count of the charging/discharging parking spaces 51 at a given storage location in the storage device 56b in association with a time at which the count of the occupied charging/discharging parking spaces 51 has been obtained. The control device 56a of the management server 56 transmits, via the communication device 56d, parking space utilization quantity information that indicates the count of the charging/discharging parking spaces 51 where the vehicles 10 are currently parked to the charging/discharging support center 40, which is connected to the network 70. The control device 56a of the management server 56 also transmits parking lot information, which indicates the total count of the charging/discharging parking spaces 51 provided in the large-scale facility 50 and the count of normal parking spaces. The information managing/providing server 41 of the charging/discharging support center 40 thus receives, via the communication device 42, the parking space utilization quantity information transmitted from the management server 56 of the large-scale facility 50, and the control device 41a stores the received information at a given storage location in the traffic information database 43 via the communication interface 41c.

After obtaining the traffic volume information from the traffic information providing center 60 and obtaining the parking space utilization quantity information from the large-scale facility 50 as described above, the control device 41a of the information managing/providing server 41 proceeds to Step S13.

In Step S13, in the information managing/providing server 41 of the charging/discharging support center 40, the control device 41a estimates changes in traffic volume in the surrounding area of the shopping mall that is the large-scale facility 50 (the traffic volume in the surrounding area is hereinafter referred to as “surrounding traffic volume Vtraffic”). A concrete description is given below on processing of estimating changes in this traffic volume.

The control device 41a first calculates the absolute quantity of the surrounding traffic volume Vtraffic. Specifically, the control device 41a calculates the surrounding traffic volume Vtraffic in the surrounding area as an absolute quantity with the use of a traffic volume Vtraffic0 (influx quantity), a count Ncd of the occupied charging/discharging parking spaces 51, and a total parking space count Nall (capacity). The traffic volume Vtraffic0 indicates the count of vehicles on a road leading to the shopping mall that is the large-scale facility 50 (a road approaching the shopping mall) and is expressed by the traffic volume information obtained in Step S12 from the traffic information providing center 60. The count Ncd is expressed by the parking space utilization quantity information obtained from the large-scale facility 50. The total parking space count Nall is expressed by the parking lot information. The control device 41 subsequently performs temporal differentiation on the surrounding traffic volume Vtraffic calculated as an absolute quantity, thereby calculating a variation dVtraffic/dt in traffic volume after a minute amount of time in the surrounding area of the shopping mall that is the large-scale facility 50. After calculating the surrounding traffic volume Vtraffic and the variation dVtraffic/dt, the control device 41a proceeds to Step S14.

In Step S14, in the information managing/providing server 41 of the charging/discharging support center 40, the control device 41a compares the surrounding traffic volume Vtraffic and variation dVtraffic/dt calculated in Step S13 with determination reference values (thresholds) A and B, which are set in advance for the surrounding traffic volume and the variation, respectively, and determines whether or not the surrounding traffic volume Vtraffic and the variation dVtraffic/dt both exceed the determination reference values (thresholds) A and B. Specifically, when the surrounding traffic volume Vtraffic is larger than the determination reference value (threshold) A and the variation dVtraffic/dt is larger than the determination reference value (threshold) B, it means that the traffic volume in the surrounding area of the shopping mall that is the large-scale facility 50 is already heavy and is further on the rise, and the control device 41a accordingly determines that the answer is “Yes” and proceeds to Step S15. When the surrounding traffic volume Vtraffic is smaller than the determination reference value (threshold) A or the variation dVtraffic/dt is smaller than the determination reference value (threshold) B, on the other hand, it means that the traffic volume in the surrounding area of the shopping mall that is the large-scale facility 50 is not heavy or is likely to decrease in accordance with the past trend, and the control device 41a accordingly determines that the answer is “No” and returns to Step S11. The control device 41a then executes steps subsequent to Step S11 to transmit and provide the normal power sales/purchase price information to the information terminal device 20 and the portable information terminal device 30.

In Step S15, in the information managing/providing server 41 of the charging/discharging support center 40, the control device 41a changes the normal power sales/purchase price information in order to effectively reduce the traffic volume in the surrounding area of the shopping mall that is the large-scale facility 50. A concrete description is given below.

As described above, providing the normal power sales/purchase price information to users (customers) of the vehicles 10 does have the effect of reducing the count of users (customers) of the vehicles 10 who visit the shopping mall during the busy hours and increasing the count of users (customers) of the vehicles 10 who visit the shopping mall during the slow hours. In actuality, however, the action of users (customers) of the vehicles 10 is based just on reference to the normal power sales/purchase price information. The count of users (customers) of the vehicles 10 who visit during the busy hours is therefore expected to increase, and the chance of an increase in traffic volume in the surrounding area of the shopping mall is consequently high.

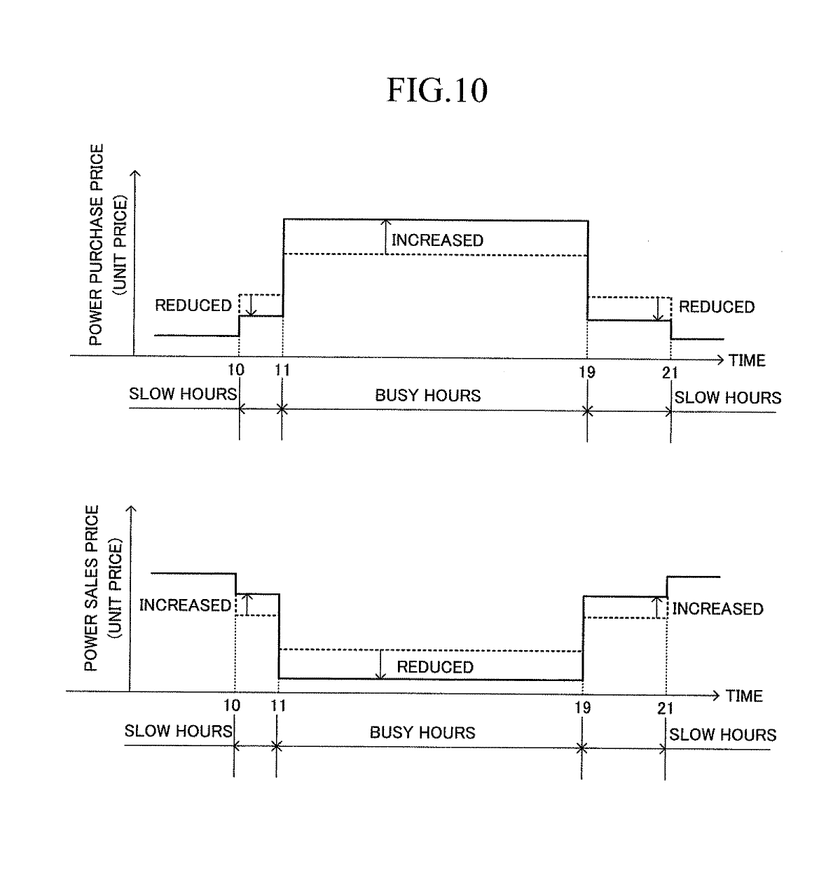

The control device 41a therefore changes the hitherto provided normal power sales/purchase price information, namely, the power purchase price (unit price) and the power sales price (unit price), so that the leveling of visits by users (customers) of the vehicles 10 to the shopping mall is advanced even more. The changed power sales/purchase price information is hereinafter referred to as “leveling power sales/purchase price information”. Specifically, the leveling power sales/purchase price information is obtained by the change made by the control device 41a as shown in FIG. 10, where the power purchase price (unit price) during the busy hours is increased and set higher than the power purchase price (unit price) that has been presented by providing the normal power sales/purchase price information, whereas the power purchase price (unit price) during the slow hours is reduced and set lower than the power purchase price (unit price) that has been presented by providing the normal power sales/purchase price information. The change made by the control device 41a also includes, as shown in FIG. 10, reducing and setting cheap the power sales price (unit price) during the busy hours than the power sales price (unit price) that has been presented by providing the normal power sales/purchase price information, whereas the power sales price (unit price) during the slow hours is increased and set higher than the power purchase price (unit price) that has been presented by providing the normal power sales/purchase price information. After changing the normal power sales/purchase price information to set the leveling power sales/purchase price information, the control device 41a proceeds to Step S16.

In Step S16, in the information managing/providing server 41 of the charging/discharging support center 40, the control device 41a transmits the leveling power sales/purchase price information set in Step S15 to the information terminal device 20 and the portable information terminal device 30 to start providing the information. In the case where it is determined in Step S14 that the traffic volume in the surrounding area of the shopping mall that is the large-scale facility 50 is further on the rise, in particular, there is a time lag from the time when the determination is made to the time when the traffic volume actually increases. By quickly starting providing the leveling power sales/purchase price information from the time when it is determined in Step S14 that the traffic volume in the surrounding area of the shopping mall that is the large-scale facility 50 is further on the rise, the user of the vehicle 10 can therefore know of a future change in power purchase price and power sales price in advance.

The user (customer) of the vehicle 10 who has been provided with the leveling power sales/purchase price information via the information terminal device 20 can thus know of a change in power purchase price and power sales price at the time when, for example, the user sets the shopping mall that is the large-scale facility 50 as a destination with the use of the navigation unit 26 of the information terminal device 20. Providing the leveling power sales/purchase price information via the information terminal device 20 in this manner effectively presents to the user (customer) of the vehicle 10 the fact that visiting the shopping mall now to sell/purchase power for the battery 11 is not in the user's best interest, and can prompt the user to visit the shopping mall that is the large-scale facility 50 at a later time.

The user (customer) of the vehicle 10 who has received the leveling power sales/purchase price information via the portable information terminal device 30 may currently be selling/purchasing power for the battery 11 with the use of the charging/discharging station 52, which is installed in each charging/discharging parking space 51 of the shopping mall. Providing the leveling power sales/purchase price information via the portable information terminal device 30 in this manner effectively presents to the user (customer) of the vehicle 10 who is already at the shopping mall the fact that selling/purchasing power for the battery 11 is not in the user's best interest for a while, and can prompt the user to go home early. The user (customer) of the vehicle 10 who is already at the shopping mall can be provided with the leveling power sales/purchase price information also by announcement over the store's PA system, for example.

By transmitting and providing such leveling power sales/purchase price information to the information terminal device 20 and the portable information terminal device 30, the action of the user (customer) of the vehicle 10 can be therefore controlled suitably, with the result that appropriate traffic volume control is accomplished in the surrounding area of the shopping mall that is the large-scale facility 50. The effect brought about by providing the leveling power sales/purchase price information may be enhanced even more by, for example, visually displaying the power sales/purchase price fluctuation situation, the timing of switching the power sales/purchase price, or the like on the display panel when the user (customer) of the vehicle 10 uses one of the information terminal device 20 and the portable information terminal device 30 to access the information managing/providing server 41 of the charging/discharging support center 40.

To give a specific example, the user (customer) of the vehicle 10 operates the input unit 22 of the information terminal device 20 (the same applies to the case of the portable information terminal device 30) to enter a request for the information managing/providing server 41 of the charging/discharging support center 40 to disclose the trend of the power sales/purchase price. The electronic control unit 21 of the information terminal device 20 transmits, via the communication unit 24, the entered request information to the information managing/providing server 41 of the charging/discharging support center 40, which is connected to the network 70. In the information managing/providing server 41 of the charging/discharging support center 40, the control device 41a obtains, via the communication interface 41c, a past fluctuation record, which is a time-series compilation of power purchase prices and power sales prices accumulated in the power sales/purchase price information database 44, and transmits past fluctuation record information that indicates the past fluctuation record to the information terminal device 20.

In the information terminal device 20, the electronic control unit 21 thus receives and obtains, via the communication unit 24, the past fluctuation record information transmitted, and stores the obtained past fluctuation record information at a given storage location in the storage unit 25. When the user (customer) of the vehicle 10 operates the input unit 22 to give an instruction to display past fluctuation record information, the electronic control unit 21 visually displays the past fluctuation record on the display panel of the display unit 23. The user (customer) of the vehicle 10 can thus check fluctuations in power sales/purchase price and the timing of future switching to the leveling power sales/purchase price information any time.

As is understood from the description given above, according to the embodiment described above, the charging/discharging support center 40 can provide, to the user of the vehicle 10, via the information terminal device 20 or the portable information terminal device 30, the leveling power sales/purchase price information that is obtained by changing the normal power sales/purchase price information, depending on the change in traffic volume (congestion situation) inside the large-scale facility 50 and in the surrounding area of the large-scale facility 50. Specifically, the information managing/providing server 41 of the charging/discharging support center 40 increases the power purchase price (unit price) during the busy hours of the large-scale facility 50 in which the facility is crowded to set the price higher than the power purchase price (unit price) that has been presented by providing the normal power sales/purchase price information, while reducing the power purchase price (unit price) during the slow hours to set the price lower than the power purchase price (unit price) that has been presented by providing the normal power sales/purchase price information. The information managing/providing server 41 of the charging/discharging support center 40 also reduces the power sales price (unit price) during the busy hours to set the price cheaper than the power sales price (unit price) that has been presented by providing the normal power sales/purchase price information, while increasing the power sales price (unit price) during the slow hours to set the price higher than the power purchase price (unit price) that has been presented by providing the normal power sales/purchase price information.

By providing the leveling power sales/purchase price information that is obtained through the change made in this manner, the action of users can be controlled effectively. The traffic volume in the surrounding area of the large-scale facility 50 can thus be leveled and the congestion of the vehicles 10 at the large-scale facility 50 is prevented effectively.

A mode for carrying out the present invention is not limited to the embodiment described above, and various modifications may be made thereto without departing from the object of the present invention.

For instance, in the embodiment described above, the charging/discharging station 52 for charging (purchasing power) and discharging (selling power) is installed in each charging/discharging parking space 51 provided in the large-scale facility 50. The present invention may be carried out by installing a charging station, which implements charging (purchasing power) alone, or a discharging station, which implements discharging (selling power) alone, may be installed instead of installing the charging/discharging station 52, which implements charging and discharging both.

In the case where the charging station alone is installed in this example, the information managing/providing server 41 of the charging/discharging support center 40 can provide, for example, normal power sales/purchase price information and leveling power sales/purchase price information that include only the power purchase price to the user of the vehicle 10 via the information terminal device 20 and the portable information terminal device 30. In the case where the discharging station alone is installed in this example, the information managing/providing server 41 of the charging/discharging support center 40 can provide, for example, normal power sales/purchase price information and leveling power sales/purchase price information that include only the power sales price to the user of the vehicle 10 via the information terminal device 20 and the portable information terminal device 30. Thus, in the case where the present invention is carried out by installing only the charging station or the discharging station, too, providing normal power sales/purchase price information and leveling power sales/purchase price information that include only the power purchase price or the power sales price to the user of the vehicle 10 levels the traffic volume in the surrounding area of the large-scale facility 50 and effectively prevents the congestion of the vehicles 10 at the large-scale facility 50 as in the embodiment described above.

In the embodiment described above, the information managing/providing server 41 (more exactly, the control device 41a) of the charging/discharging support center 40 determines whether or not the surrounding traffic volume Vtraffic, which takes into account the charging/discharging parking space count Ncd of the large-scale facility 50 and the total parking space count Nall thereof, is larger than the determination reference value (threshold) A and the variation dVtraffic/dt is larger than the determination reference value (threshold) B in Step S14 of the charging/discharging support program. The present invention may also be carried out in the following manner. Specifically, the information managing/providing server 41 determines the congestion situation inside the large-scale facility 50 based on, for example, the count Ncd (absolute quantity) of the occupied charging/discharging parking spaces 51 that is expressed by the parking space utilization quantity information obtained from the large-scale facility 50 and on the amount of change with time of the count of the occupied charging/discharging parking spaces 51, in short, based solely on the situation inside the large-scale facility 50, so that the provided information is changed from the normal power sales/purchase price information to the leveling power sales/purchase price information depending on the determined congestion situation. In this case, leveling the congestion inside the large-scale facility 50 levels the congestion situation (traffic volume) of a road leading to the large-scale facility 50 as well, and the same effect that is obtained in the embodiment described above can therefore be expected.

In the embodiment described above, the user (customer) of the vehicle 10 is informed of the changed power purchase price or power sales price by the provided leveling power sales/purchase price information, when the information managing/providing server 41 (more exactly, the control device 41a) of the charging/discharging support center 40 has started providing the leveling power sales/purchase price information and the user sets a destination with the use of the navigation unit 26 of the information terminal device 20. The present invention may also be carried out so that the information managing/providing server 41 provides at least the leveling power sales/purchase price information when the vehicle 10 approaches to within a given distance of the large-scale facility 50.

Specifically, the information terminal device 20 in this case transmits to the information managing/providing server 41 of the charging/discharging support center 40 current location information that indicates the current location of the vehicle 10 detected with the use of the navigation unit 26. With the providing of the leveling power sales/purchase price information started by executing Step S16 of the charging/discharging support program described above, the control device 41a in the information managing/providing server 41 obtains the current location information transmitted from the information terminal device 20 (namely, the vehicle 10). The control device 41a can provide the leveling power sales/purchase price information to the information terminal device 20 mounted on the vehicle 10 when the current location of the vehicle 10 that is indicated by the obtained current location information is within a given distance of the large-scale facility 50 that is set in advance.

By thus providing at least the leveling power sales/purchase price information when the vehicle 10 approaches to within a given distance of the large-scale facility 50, the traffic volume in the surrounding area of the large-scale facility 50 can be leveled and the congestion of the vehicles 10 at the large-scale facility 50 can also be effectively prevented, as in the embodiment described above. In this case, the leveling power sales/purchase price information may be transmitted and provided to the portable information terminal device 30 kept by the user who is riding in the vehicle 10 instead of, or in addition to, transmitting (providing) the leveling power sales/purchase price information to the information terminal device 20 mounted on the vehicle 10.

In the embodiment described above, the information managing/providing server 41 of the charging/discharging support center 40 transmits and provides to the information terminal device 20 and the portable information terminal device 30 the leveling power sales/purchase price information obtained by changing the power sales/purchase price that is indicated by the normal power sales/purchase price information. When the large-scale facility 50 is a store such as a shopping mall which the user (customer) of the vehicle 10 visits for shopping, in particular, the present invention may also be carried out by, instead of or in addition to changing the price at which power is sold and purchased for the battery 11, changing the rate of rewarding points which the user (customer) of the vehicle 10 can use for shopping at the store. Specifically, the point rewarding rate is lowered during the busy hours of the shopping mall and is increased during the slow hours of the shopping mall. In this manner, too, the traffic volume in the surrounding area of the large-scale facility 50 can be leveled and the congestion of the vehicles 10 at the large-scale facility 50 is prevented effectively as in the embodiment described above.

In the embodiment described above, the information managing/providing server 41 of the charging/discharging support center 40 transmits and provides to the information terminal device 20 and the portable information terminal device 30 the leveling power sales/purchase price information obtained by changing the power sales/purchase price that is indicated by the normal power sales/purchase price information. The present invention may also be carried out by, for example, setting the length of time in which the charging/discharging station 52 installed in each charging/discharging parking space 51 is available for use during the busy hours shorter (specifically, thirty minutes or so) than the length of time in which the charging/discharging station 52 is available for use during the slow hours, in order to level the traffic volume in the surrounding area of the large-scale facility 50 and effectively prevent the congestion of the vehicles 10 at the large-scale facility 50. In this manner, too, leveling congestion inside the large-scale facility 50 levels the congestion situation (traffic volume) of a road leading to the large-scale facility 50 as well, and the same effect that is obtained in the embodiment described above can therefore be expected.

In the embodiment described above, the normal power sales/purchase price information and the leveling power sales/purchase price information are transmitted and provided to each information terminal device 20 and each portable information terminal device 30 that are used by a user of the vehicle 10. The present invention may also be carried out by, instead of or in addition to providing (presenting) the normal power sales/purchase price information and the leveling power sales/purchase price information with the use of each individual information terminal device 20 and portable information terminal device 30, providing (presenting) the normal power sales/purchase price information and the leveling power sales/purchase price information with the use of, for example, an electric bulletin board that is installed by the side of a road and whose display operation is controlled by the information managing/providing server 41 of the charging/discharging support center 40. In this manner, too, the normal power sales/purchase price information and the leveling power sales/purchase price information can be provided (presented) to the user of the vehicle 10, and the traffic volume in the surrounding area of the large-scale facility 50 can therefore be leveled and the congestion of the vehicles 10 at the large-scale facility 50 is prevented effectively as in the embodiment described above.

1. A charging/discharging support device for assisting in charging or discharging a battery of a plug-in electric vehicle in a charging/discharging parking space by charging/discharging means for at least charging the battery of the plug-in electric vehicle out of charging and discharging, the charging/discharging means being provided in the charging/discharging parking space, the charging/discharging parking space being provided at a facility including a parking lot for parking a plurality of vehicles, the charging/discharging support device comprising:
congestion information obtaining means for obtaining congestion information that indicates a congestion situation inside the facility or around the facility;
charging/discharging-related information changing means for changing information about the charging or discharging of the battery by the charging/discharging means, depending on the congestion situation that is indicated by the congestion information obtained by the congestion information obtaining means; and
presenting means for presenting to a user of the plug-in electric vehicle the information about the charging or discharging of the battery by the charging/discharging means that has been changed by the charging/discharging-related information changing means.

2. A charging/discharging support device according to claim 1,
wherein the information about the charging or discharging of the battery by the charging/discharging means comprises a condition for charging the battery by the charging/discharging means, and comprises information about a power purchase price of power purchased to charge the battery, and
wherein the charging/discharging-related information changing means changes the information about the charging or discharging of the battery by the charging/discharging means so that the power purchase price of power purchased to charge the battery is higher when the congestion information obtained by the congestion information obtaining means indicates that the inside of the facility or surroundings of the facility are crowded, than when the inside of the facility or surroundings of the facility are not crowded.

3. A charging/discharging support device according to claim 1,
wherein the information about the charging or discharging of the battery by the charging/discharging means comprises a condition for discharging the battery by the charging/discharging means, and comprises information about a power sales price of power discharged from the battery for sale, and
wherein the charging/discharging-related information changing means changes the information about the charging or discharging of the battery by the charging/discharging means so that the power sales price of power discharged from the battery is for sale lower when the congestion information obtained by the congestion information obtaining means indicates that the inside of the facility or surroundings of the facility are crowded, than when the inside of the facility or surroundings of the facility are not crowded.

4. A charging/discharging support device according to claim 1,
wherein the congestion information obtaining means comprises traffic volume obtaining means for obtaining a traffic volume around the facility, and
wherein the congestion information obtaining means obtains congestion information that indicates the congestion situation with use of the traffic volume around the facility obtained by the traffic volume obtaining means.

5. A charging/discharging support device according to claim 4,
wherein the congestion information obtaining means further comprises traffic volume temporal differentiation means for performing temporal differentiation on the traffic volume obtained by the traffic volume obtaining means, and
wherein the congestion information obtaining means obtains congestion information that indicates a future congestion situation inside the facility or around the facility, which is predicted with use of the traffic volume obtained by the traffic volume obtaining means and a temporal differentiation value of the traffic volume calculated through temporal differentiation by the traffic volume temporal differentiation means.

6. A charging/discharging support device according to claim 1, wherein the presenting means presents, at least, the information about the charging or discharging of the battery by the charging/discharging means that has been changed by the charging/discharging-related information changing means when the plug-in electric vehicle approaches to within a given distance of the facility that is set in advance.

7. A charging/discharging support device according to claim 1, wherein the presenting means presents, at least, the information about the charging or discharging of the battery by the charging/discharging means that has been changed by the charging/discharging-related information changing means when a destination is set in a navigation unit that is usable by a user of the plug-in electric vehicle.

8. A charging/discharging support device according to claim 2,
wherein the information about the charging or discharging of the battery by the charging/discharging means comprises a condition for discharging the battery by the charging/discharging means, and comprises information about a power sales price of power discharged from the battery for sale, and
wherein the charging/discharging-related information changing means changes the information about the charging or discharging of the battery by the charging/discharging means so that the power sales price of power discharged from the battery is for sale lower when the congestion information obtained by the congestion information obtaining means indicates that the inside of the facility or surroundings of the facility are crowded, than when the inside of the facility or surroundings of the facility are not crowded.
